(19) United States
(12) Patent Application Publication
(10) Pub. No.: US 2026/0063101 A1
(43) Pub. Date: Mar. 5, 2026

(54) WAVE ENERGY-BASED REEF SUSTAINABLE DEVICE INTEGRATED WITH OFFSHORE WIND TURBINE

(71) Applicant: National Cheng Kung University, Tainan City (TW)

(72) Inventor: TING-CHIA OU, Tainan City (TW)

(21) Appl. No.: 19/312,731

(22) Filed: Aug. 28, 2025

(30) Foreign Application Priority Data
Sep. 2, 2024 (TW) 113133107

(51) Int. Cl. F03B 13/18; F03D 13/25

(52) U.S. Cl. CPC F03B 13/18; F03D 13/25; F05B 2240/93; F05B 2240/95

(57) ABSTRACT

A wave energy-based reef sustainable device integrated with an offshore wind turbine is provided. The wave energy-based reef sustainable device integrated with an offshore wind turbine can be put into a seabed, is configured to connect with a floating wind turbine, and includes a base is configured as a fish reef, an anchoring device configured to connect with the floating wind turbine, and includes plural rings with a luminous coating and at least one mooring system or cable with a luminous layer. The rings swing and/or rotate due to the pull of the floating wind turbine and present a flashing effect to attract fish. The mooring system or cable with the luminous layer provides a warning effect, a lighting device configured to emit light to attract fish, and a green energy device configured to convert a green energy into an electrical energy, which is provided to the lighting device.

### CROSS-REFERENCE TO RELATED APPLICATION

This application claims the benefit of Taiwan Patent Application No. 113133107, filed on Sep. 2, 2024, which is hereby incorporated by reference for all purposes as if fully set forth herein.

### TECHNICAL FIELD

The present disclosure relates to a base structure, and in particular, to a wave energy-based reef sustainable device integrated with an offshore wind turbine.

### BACKGROUND ART

When an existing wind turbine base structure is arranged on a seabed, fixing piles need to be drilled into the seabed to fix the wind turbine base structure to the seabed. Therefore, in addition to complex construction, the arrangement of the existing wind turbine base structure will also damage the seabed and affect the ecological environment thereof. Therefore, there is still room for improvement.

### SUMMARY

Therefore, an objective of the present disclosure is to provide a wave energy-based reef sustainable device integrated with an offshore wind turbine, in order to address the issues of the existing wind turbine base being complex in construction, damaging the seabed, and affecting the ecology.

According to the above-mentioned objectivpe of the present disclosure, a wave energy-based reef sustainable device integrated with the offshore wind turbine is provided. The wave energy-based reef sustainable device integrated with the offshore wind turbine may be put on the seabed and is configured to connect to a floating wind turbine. The wave energy-based reef sustainable device integrated with the offshore wind turbine includes a base body, an anchoring device, retaining rings, a lighting device and a green energy device. The base body is made of reinforced concrete with negative cement and is configured to serve as a reef. The anchoring device is arranged on the base body and is configured to connect to the floating wind turbine. The anchoring device includes the retaining rings and a mooring system or cable. The retaining rings are arranged on the base body and are spaced apart from each other. Each retaining ring includes a light-emitting coating, where the light-emitting coating is configured to emit light and gather fishes. Two ends of the mooring system or cable are connected to the corresponding floating wind turbine and the corresponding retaining ring, respectively. The mooring system or cable has a light-emitting layer. The lighting device is arranged in the base body and is configured to emit light and gather fishes. The green energy device is arranged on the base body, is electrically connected to the lighting device and is configured to convert green energy into electric energy and supply the same to the lighting device.

According to an embodiment of the present disclosure, in each of the above-mentioned retaining rings, the light-emitting coating is an outer side coating of the retaining ring; or the light-emitting coating is arranged on an inner ring surface or an outer ring surface of the retaining ring, the outer ring surface surrounding the inner ring surface; or the light-emitting coating is arranged on a front side surface or a rear side surface of the retaining ring, the rear side surface being opposite to the front side surface.

According to an embodiment of the present disclosure, in each of the above-mentioned retaining rings, a coating area of the light-emitting coating is ½ of a surface area of the retaining ring.

According to an embodiment of the present disclosure, in the above-mentioned mooring system or cable, a coating area of the light-emitting layer is equal to a surface area of the mooring system or cable, or the coating area of the light-emitting layer is ½ of the surface area of the mooring system or cable.

According to an embodiment of the present disclosure, in the above-mentioned mooring system or cable, the coating area of the light-emitting layer is ½ of the surface area of the mooring system or cable.

According to an embodiment of the present disclosure, the above-mentioned base body includes a transverse channel. The transverse channel transversely passes through the base body.

According to an embodiment of the present disclosure, the above-mentioned base body further includes a longitudinal channel. The longitudinal channel longitudinally passes through the base body and is connected to the transverse channels.

According to an embodiment of the present disclosure, the above-mentioned base body is a cone-shaped structure body.

According to an embodiment of the present disclosure, the above-mentioned green energy device is a wave energy device, and is configured to convert wave energy into electric energy and supply the same to the lighting device.

According to an embodiment of the present disclosure, the above-mentioned green energy device is a solar energy device, and is configured to convert solar energy into the electric energy and supply the same to the lighting device.

According to an embodiment of the present disclosure, a plant-based bottom layer is arranged on the above-mentioned base body.

As can be seen from the above, the wave energy-based reef sustainable device integrated with the offshore wind turbine according to the present disclosure can be put on the seabed, and the base body uses the self-weight to be positioned on the seabed. Therefore, in addition to simple construction, the base body is arranged without damaging the seabed and can thus be suitable for different seabed environments. In addition, the retaining rings with the light-emitting coatings can be pulled by the floating wind turbine to further provide a flickering light-emitting effect to gather fishes. The lighting device can also emit light and gather fishes. Therefore, by means of the light-emitting coatings, the lighting device and the base body as the reef, fishes can be effectively attracted to be gathered and live in the base body, thereby effectively restoring fish sources, increasing biological richness and diversity and improving the sustainable development of the ecology. In addition, the mooring system or cable with the light-emitting layer can alert that a vessel enters a wind field, thereby achieving the purpose of providing a warning function. Moreover, the green energy device converts green energy into electric energy for the lighting device, thereby achieving the purpose of effectively using the green energy. In addition, the configurations of the plant-based bottom layer and the lighting device are conducive to plant growth and carbon fixation, thereby achieving the purpose of natural carbon sequestration.

### BRIEF DESCRIPTION OF THE DRAWINGS

To make the above and other objectives, features, advantages and embodiments of the present disclosure more apparent and comprehensible, the accompanying drawings are explained as follows:

FIG. 1 is a schematic diagram of a use state of a wave energy-based reef sustainable device integrated with an offshore wind turbine according to an implementation of the present disclosure;

FIG. 2 is a schematic three-dimensional diagram of a base body according to the implementation of the present disclosure;

FIG. 3A is a partially enlarged front view of a retaining ring according to the implementation of the present disclosure;

FIG. 3B is a partially enlarged front view of a retaining ring according to another implementation of the present disclosure;

FIG. 3C is a partially enlarged side view of a retaining ring according to still another implementation of the present disclosure;

FIG. 4A is a partially enlarged front view of a mooring system or cable according to an implementation of the present disclosure;

FIG. 4B is a partially enlarged front view of a mooring system or cable according to another implementation of the present disclosure; and

FIG. 5 is a schematic diagram of a use state of a wave energy-based reef sustainable device integrated with an offshore wind turbine according to another implementation of the present disclosure.

### DETAILED DESCRIPTION OF THE EMBODIMENTS

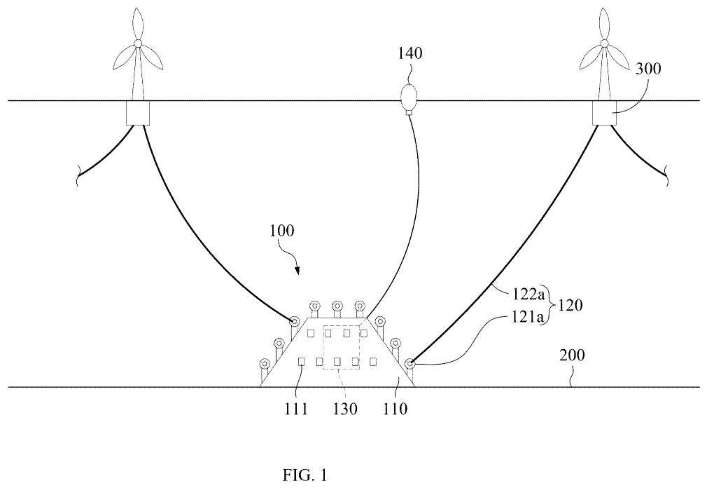

Reference is made to FIG. 1, which is a schematic diagram of a use state of a wave energy-based reef sustainable device 100 integrated with an offshore wind turbine according to an implementation of the present disclosure. The wave energy-based reef sustainable device 100 integrated with the offshore wind turbine in this implementation may be put on a seabed 200 and uses the self-weight for positioning. Therefore, there is absolutely no need to drive anchor piles into the seabed 200. The wave energy-based reef sustainable device 100 integrated with the offshore wind turbine is configured to connect to floating wind turbines 300. The wave energy-based reef sustainable device 100 integrated with the offshore wind turbine includes a base body 110, anchoring devices 120, a lighting device 130 and a green energy device 140.

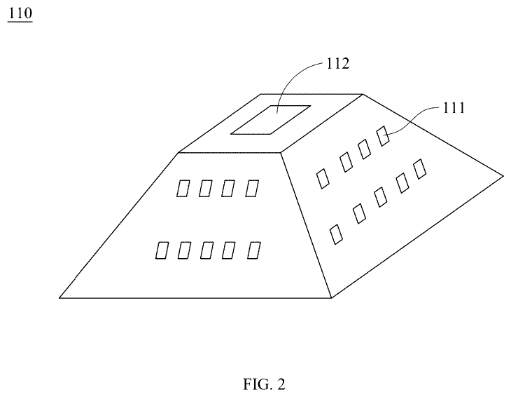

Reference is made to FIG. 2, which is a schematic three-dimensional diagram of the base body 110 according to the implementation of the present disclosure. The base body 110 is made of reinforced concrete with negative cement and is configured to serve as a reef. The base body 110 may use the self-weight to sink to a predetermined position of a seabed 200 for positioning. That is, the base body 110 does not require a complex anchoring foundation for mounting, thereby saving the mounting and construction costs of the anchoring foundation. Therefore, the base body 110 is arranged without damaging the seabed 200 and can thus be suitable for seabeds 200 of various geologies and reduce the damage to the ecology.

In an example, the base body 110 includes a plurality of transverse channels 111. Each transverse channel 111 may transversely pass through the base body 110 and extend from one side surface of the base body 110 to an opposite side surface. In an example, the base body 110 includes one or more longitudinal channels 112. Each longitudinal channel 112 may longitudinally pass through the base body 110 and extend from a top surface of the base body 110 to a bottom surface. The longitudinal channel 112 may be connected to the transverse channels 111. Through the arrangement of the transverse channels 111 and the longitudinal channels 112, a habitat space for aquatic organisms such as fishes can be created.

Still referring to FIG. 2, the base body 110 is a cone-shaped structure body, but is not limited thereto. The base body 110 may also be a polygonal columnar body or a cylinder. In some examples, an area of the bottom surface of the base body 110 is greater than an area of the top surface of the base body 110, thereby improving the stability of the base body 110 placed on the seabed 200.

Referring again to FIG. 1, each anchoring device 120 is arranged on the base body 110 and is configured to connect to the corresponding floating wind turbine 300. Each anchoring device 120 includes a plurality of retaining rings 121a and a mooring system or cable 122a. The retaining rings 121a are arranged on the base body 110 and are spaced apart from each other. The retaining rings 121a may shake and rotate on the base body 110. In an example, the retaining rings 121a may be arranged on the top surface and the side surfaces of the base body 110 to provide a greater selection of connecting positions.

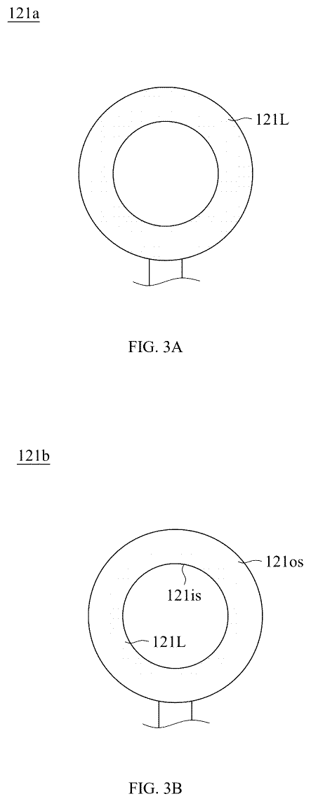

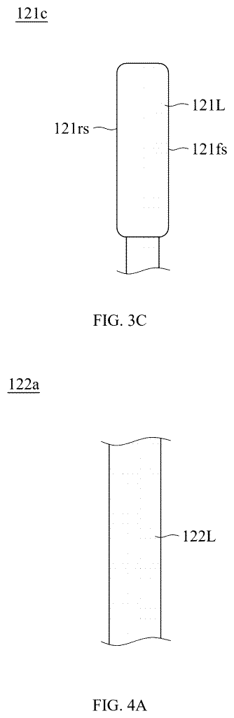

Next, reference is made to FIG. 3A to FIG. 3C, which are partially enlarged front views of retaining rings 121a and retaining rings 121b and a partially enlarged side view of retaining rings 121c according to different implementations of the present disclosure, respectively. Each of the retaining rings 121a, 121b and 121c includes a light-emitting coating 121L. The light-emitting coating 121L is configured to emit light and gather shoals of fish. As shown in FIG. 3A, in the retaining ring 121a, the light-emitting coating 121L is an outer side coating of the retaining ring 121a. As shown in FIG. 3B, the retaining ring 121b includes an inner ring surface 121is and an outer ring surface 121os that are opposite to each other in an interior-exterior direction. The outer ring surface 121os surrounds the inner ring surface 121is. The light-emitting coating 121L may be arranged on the inner ring surface 121is or the outer ring surface 121os. As shown in FIG. 3C, the retaining ring 121c includes a front side surface 121fs and a rear side surface 121rs that are opposite to each other in a front-rear direction. The light-emitting coating 121L is arranged on the front side surface 121fs or the rear side surface 121rs. The distribution pattern of the light-emitting coating 121L is not limited to the above and can be adjusted according to application requirements. In an example, a coating area of the light-emitting coating 121L is ½ of a surface area of the retaining ring 121c.

Referring again to FIG. 1, each floating wind turbine 300 is driven by wave energy and then pulls the corresponding retaining ring 121a through the corresponding mooring system or cable 122a, causing the corresponding retaining ring 121a to shake and/or rotate. As shown in FIG. 3C, when viewed at a fixed angle, and when the retaining ring 121c with the light-emitting coating 121L shakes or rotates, the light-emitting area will change to generate a flickering effect, thereby attracting shoals of fish to achieve the purpose of gathering fishes.

Still referring to FIG. 1, two ends of each mooring system or cable 122a are connected to the corresponding floating wind turbine 300 and the corresponding retaining ring 121a, respectively. The mooring system or cable 122a may change the retaining ring 121a connected thereto according to conditions of a wind field and an offshore current, such that the tension of the mooring system or cable 122a is adjusted into an appropriate range to improve the stability of the power supply capacity and the system resilience. In addition, the retaining ring 121a connected to the mooring system or cable 122a may also be adjusted according to different types of floating wind turbines 300. Therefore, the wave energy-based reef sustainable device 100 integrated with the offshore wind turbine can be suitable for different floating wind turbines 300, such as floating wind turbines in which a tension leg platform (TLP), a semi-submersible platform or a spar-buoy is used as a floating structure, thereby increasing the diversity of green energy-based electricity generation. In addition, the mounting length of the mooring system or cable 122a may also be reduced according to environmental requirements.

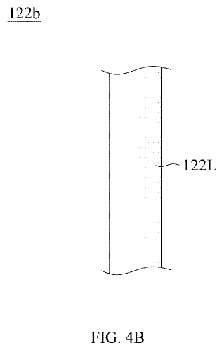

Next, reference is made to FIG. 4A and FIG. 4B, which are partially enlarged front views of mooring systems or cables 122a and 122b according to different implementations of the present disclosure, respectively. Each of the mooring systems or cables 122a and 122b has a light-emitting layer 122L. As shown in FIG. 4A, the light-emitting layer 122L completely covers the entire mooring system or cable 122a. That is, a coating area of the light-emitting layer 122L is equal to a surface area of the mooring system or cable 122a. As shown in FIG. 4B, the light-emitting layer 122L does not completely cover the entire mooring system or cable 122b. For example, the coating area of the light-emitting layer 122L may be ½ of a surface area of the mooring system or cable 122b.

The above-mentioned mooring systems or cables 122a and 122b with the light-emitting layers 122L can emit light to provide a warning. Therefore, when seeing the light emitted by the light-emitting layers 122L of the undersea mooring systems or cables 122a and 122b, a vessel can know that it enters a wind field. The fishing vessel may adjust a route to leave the wind field to avoid affecting the ecology of shoals of fish that are restored by the wave energy-based reef sustainable device 100 integrated with the offshore wind turbine. Therefore, the mooring systems or cables 122a and 122b with the light-emitting layers 122L can provide a warning for marine conservation areas or closed fishing areas. In addition, the light-emitting layers 122L and the light-emitting coatings 121L may emit light at night, thereby providing a safety warning for construction vessels or maintenance vessels. Furthermore, the mooring systems or cables 122a and 122b uses the light-emitting layers 122L to emit light, such that large fish species can be attracted from afar, thereby increasing the biological richness and diversity of gathered fishes.

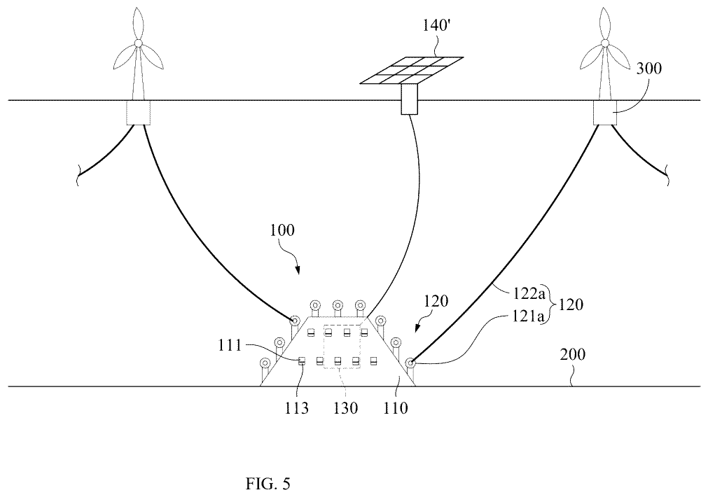

Still referring to FIG. 1, the lighting device 130 is arranged in the base body 110 and is configured to emit light and gather fishes. The light emitted by the lighting device 130 may transmit through the base body 110 through the transverse channels 111 and/or the longitudinal channels 112. Therefore, fishes can be effectively attracted to inhabit the base body 110 by using the phototaxis of the fishes. Next, reference is made to FIG. 5, which is a schematic diagram of a use state of a wave energy-based reef sustainable device 100 integrated with an offshore wind turbine according to another implementation of the present disclosure. The base body 110 may be provided with plant-based bottom layers 113. The plant-based bottom layers 113 are located in the transverse channels 111 and/or the longitudinal channels 112 and may further extend to outer side surfaces of the base body 110. The plant-based bottom layers 113 are conducive to the growth of aquatic plants such as Posidonia oceanica. Therefore, the aquatic plants may be attached to the base body 110 through the plant-based bottom layers 113. The aquatic plants growing on the base body 110 may use the light emitted by the lighting device 130 to carry out photosynthesis, thereby improving the effect of carbon sequestration. Therefore, regardless of the depth of the seabed on which the base body 110 sinks, the plant-based bottom layers 113 can cooperate with the lighting device 130 to promote the growth of the aquatic plants and achieve carbon sequestration, thereby further achieving the purpose of natural carbon sequestration.

Still referring to FIG. 1 to FIG. 5, green energy devices 140 and 140′ are arranged on the base body 110 and are electrically connected to the lighting device 130. As shown in FIG. 1, the green energy device 140 may be a wave energy device that is configured to convert wave energy into electric energy and supply the electric energy to the lighting device 130. Furthermore, as shown in FIG. 5, the green energy device 140′ may be a solar energy device that may be float on a water surface and is configured to convert solar energy into electric energy and supply the electric energy to the lighting device 130. Therefore, the cooperation between the green energy devices 140 and 140′ and the lighting device 130 can achieve green energy-based electricity generation and supply electricity to the lighting device 130 without additional arrangement of an external power supplying device. In an example, the wave energy-based reef sustainable device 100 integrated with the offshore wind turbine may be laid to combine the wave energy device, the solar energy device and the floating wind turbines 300.

As can be seen from the above-mentioned implementations, the present disclosure has one advantage that since the wave energy-based reef sustainable device integrated with the offshore wind turbine according to the present disclosure can be put on the seabed, and the base body uses the self-weight to be positioned on the seabed, in addition to simple construction, the base body is arranged without damaging the seabed and can thus be suitable for different seabed environments. In addition, the retaining rings with the light-emitting coatings can be pulled by the floating wind turbines, thereby further providing a flickering light-emitting effect to gather fishes. Therefore, the lighting device can also emit light and gather fishes. By means of the light-emitting coatings, the lighting device and the base body as the reef, fishes can be effectively attracted to be gathered and live in the base body, thereby effectively restoring fish sources, increasing biological richness and diversity and improving the sustainable development of the ecology. In addition, the mooring systems or cables with the light-emitting layers can alert that a vessel enters a wind field, thereby achieving the purpose of providing a warning function. Moreover, the green energy device converts green energy into electric energy for the lighting device, thereby achieving the purpose of effectively using the green energy.

Although the present disclosure has been disclosed as above with embodiments, it is not intended to limit the present disclosure, and any of those of ordinary skill in the technical field may make various changes and modifications without departing from the spirit and scope of the present disclosure. Therefore, the scope of protection of the present disclosure shall be defined in the attached scope of application for patent.

What is claimed is:

1. A wave energy-based reef sustainable device integrated with an offshore wind turbine, capable of being put on a seabed and configured to connect to at least one floating wind turbine, the wave energy-based reef sustainable device integrated with the offshore wind turbine comprising:
a base body, wherein the base body is made of reinforced concrete with negative cement and is configured to serve as a reef;
an anchoring device arranged on the base body and configured to connect to the at least one floating wind turbine, wherein the anchoring device comprises:
a plurality of retaining rings arranged on the base body and spaced apart from each other, wherein each of the retaining rings comprises a light-emitting coating, the light-emitting coating being configured to emit light and gather fishes; and
at least one mooring system or cable, wherein two ends of each of the at least one mooring system or cable are connected to the corresponding one of the at least one floating wind turbine and the corresponding one of the retaining rings, respectively, and each of the at least one mooring system or cable has a light-emitting layer;
a lighting device arranged in the base body and configured to emit light and gather fishes; and
a green energy device arranged on the base body, electrically connected to the lighting device and configured to convert green energy into electric energy and supply same to the lighting device.

2. The wave energy-based reef sustainable device integrated with the offshore wind turbine according to claim 1, wherein in each of the retaining rings, the light-emitting coating is an outer side coating of the retaining ring; or the light-emitting coating is arranged on an inner ring surface or an outer ring surface of the retaining ring, the outer ring surface surrounding the inner ring surface; or the light-emitting coating is arranged on a front side surface or a rear side surface of the retaining ring, the rear side surface being opposite to the front side surface.

3. The wave energy-based reef sustainable device integrated with the offshore wind turbine according to claim 1, wherein in each of the retaining rings, a coating area of the light-emitting coating is ½ of a surface area of the retaining ring.

4. The wave energy-based reef sustainable device integrated with the offshore wind turbine according to claim 1, wherein in each of the at least one mooring system or cable, a coating area of the light-emitting layer is equal to a surface area of the mooring system or cable, or the coating area of the light-emitting layer is ½ of the surface area of the mooring system or cable.

5. The wave energy-based reef sustainable device integrated with the offshore wind turbine according to claim 1, wherein the base body comprises a plurality of transverse channels, the transverse channels transversely passing through the base body.

6. The wave energy-based reef sustainable device integrated with the offshore wind turbine according to claim 5, wherein the base body further comprises at least one longitudinal channel, which longitudinally passes through the base body and connects to at least one of the transverse channels.

7. The wave energy-based reef sustainable device integrated with the offshore wind turbine according to claim 5, wherein the base body is a cone-shaped structure body.

8. The wave energy-based reef sustainable device integrated with the offshore wind turbine according to claim 1, wherein the green energy device is a wave energy device that is configured to convert wave energy into the electric energy and supply the same to the lighting device.

9. The wave energy-based reef sustainable device integrated with the offshore wind turbine according to claim 1, wherein the green energy device is a solar energy device that is configured to convert solar energy into the electric energy and supply the same to the lighting device.

10. The wave energy-based reef sustainable device integrated with the offshore wind turbine according to claim 1, wherein a plant-based bottom layer is arranged on the base body.
